(19) United States
(12) Patent Application Publication
(10) Pub. No.: US 2024/0356380 A1
(43) Pub. Date: Oct. 24, 2024

(54) WIRELESS CHARGING SYSTEM FOR ATTENUATING ELECTROMAGNETIC WAVES

(71) Applicant: ELECTRONICS AND TELECOMMUNICATIONS RESEARCH INSTITUTE, Daejeon (KR)

(72) Inventors: Sang-Won KIM, Daejeon (KR); Gwangzeen KO, Daejeon (KR); Seong-Min KIM, Daejeon (KR); Kyeseok YOON, Sejong-si (KR); In Kui CHO, Daejeon (KR)

(73) Assignee: ELECTRONICS AND TELECOMMUNICATIONS RESEARCH INSTITUTE, Daejeon (KR)

(21) Appl. No.: 18/592,509

(22) Filed: Feb. 29, 2024

(30) Foreign Application Priority Data
Apr. 20, 2023 (KR) 10-2023-0051981
Dec. 13, 2023 (KR) 10-2023-0180874

(51) Int. Cl. H02J 50/40; H02J 50/12; H02J 50/70

(52) U.S. Cl. CPC H02J 50/402; H02J 50/12; H02J 50/70

(57) ABSTRACT

A wireless charging system for attenuating electromagnetic waves is provided. The wireless charging system includes a transmitter including a clock generator configured to generate clock signals having reverse phases from each other, inverters configured to output inverter voltage/current signals having a same magnitude and reverse phases from each other using the clock signals generated by the clock generator, matching portions respectively connected to the inverters and configured to output transmission coil voltage/current signals having a same magnitude and reverse phases from each other using the inverter voltage/current signals, and transmission coils respectively connected to the matching portions and configured to generate magnetic fields towards a reception coil using the transmission coil voltage/current signals.

### CROSS-REFERENCE TO RELATED APPLICATION

This application claims the benefit of Korean Patent Application No. 10-2023-0051981, filed on Apr. 20, 2023, and Korean Patent Application No. 10-2023-0180874, filed on Dec. 13, 2023, in the Korean Intellectual Property Office, the entire disclosures of which are incorporated herein by reference for all purposes.

### BACKGROUND

### 1. Field of the Invention

One or more embodiments relate to a method of reducing unnecessary electromagnetic waves generated by a transmitter of a wireless charging system with regard to wireless charging technology or wireless power transmission technology.

### 2. Description of the Related Art

Wireless power transmission technology and wireless charging technology are being actively used in small Internet of things (IoT) devices, such as smartwatches or mobile phones requiring low power less than 15 watts (W). Recently, there has been active research on a method of applying wireless charging technology instead of the existing wired charging technology to charge batteries of automated guided vehicles (AGVs) (e.g., 3.3 kilowatts (kW)) and electric vehicles (e.g., 22 kW).

However, a wireless charging system for AGVs and electric vehicles has an issue of increasing electromagnetic wave signal components (e.g., electromagnetic interference (EMI) or electromagnetic compatibility (EMC)) travelling in the space due to the high power used. Such an increase in the components of electromagnetic wave signals is emerging as the biggest issue for commercialization, and thus, technology of reducing the electromagnetic wave signals is required.

Furthermore, the wireless charging technology is mainly based on a 1:1 wireless charging method using a single transceiver, but recently, a multi-wireless charging method of wirelessly charging multiple receivers simultaneously using a single transmitter has been actively researched. Applying the multi-wireless charging technology of wirelessly charging multiple receivers simultaneously has many advantages in terms of installation area, installation cost, and charging efficiency of a wireless charging system. Therefore, it is required to develop technology of wireless charging of multiple receivers using multiple transmission and reception coils and at the same time generating less unnecessary electromagnetic waves.

### SUMMARY

Embodiments are to provide a structure of a transmitter to reduce unnecessary electromagnetic waves generated in a wireless charging system.

Embodiments are to provide a structure of a transmitter in a multi-wireless charging method of wirelessly charging multiple receivers simultaneously through a single transmitter. However, the technical aspects are not limited to the aforementioned aspects, and other technical aspects may be present.

According to an aspect, there is provided a wireless charging system including a transmitter including a clock generator configured to generate clock signals having reverse phases from each other, inverters configured to output inverter voltage/current signals having a same magnitude and reverse phases from each other using the clock signals generated by the clock generator, matching portions respectively connected to the inverters and configured to output transmission coil voltage/current signals having a same magnitude and reverse phases from each other using the inverter voltage/current signals, and transmission coils respectively connected to the matching portions and configured to generate magnetic fields towards a reception coil using the transmission coil voltage/current signals, wherein the transmitter may be configured to attenuate unnecessary electromagnetic waves radiated from the transmitter by the inverter voltage/current signals that are output from the inverters and that have the same magnitude and the reverse phases from each other and by the transmission coil voltage/current signals that are output from the matching portions and that have the same magnitude and the reverse phases from each other.

The inverters, the matching portions, and the transmission coils may be arranged in parallel on a same plane.

The transmission coils, in which conducting wires are wound in a same direction, may be arranged such that central axes of the transmission coils are aligned, and the magnetic fields overlap each other, to increase a charging distance and charging power of wireless power for a single reception coil.

The transmission coils, in which conducting wires are wound in a same direction, may be arranged such that central axes of the transmission coils are parallel to each other, to transmit wireless power to a plurality of reception coils.

The transmission coils, in which conducting wires are wound in opposite directions, may be arranged such that central axes of the transmission coils are aligned, and the magnetic fields are canceled out, to reduce electromotive force (EMF).

According to another aspect, there is provided a wireless charging system including a transmitter including a clock generator configured to generate clock signals, first inverters configured to output inverter voltage/current signals having a first phase using a first clock signal among the clock signals generated by the clock generator, second inverters configured to output inverter voltage/current signals having a second phase using a second clock signal having a reverse phase from the first clock signal among the clock signals, first matching portions respectively connected to the first inverters and configured to output transmission coil voltage/current signals having the first phase using the inverter voltage/current signals having the first phase, second matching portions respectively connected to the second inverters and configured to output transmission coil voltage/current signals having the second phase using the inverter voltage/current signals having the first phase, and transmission coils respectively connected to the first matching portions and the second matching portions and configured to generate magnetic fields towards a reception coil using the transmission coil voltage/current signals having the first phase and the transmission coil voltage/current signals having the second phase.

The first inverters and the second inverters may be configured to be set so that a sum of the transmission coil voltage/current signals having the first phase is equal to a sum of the transmission coil voltage/current signals having the second phase.

The first inverters, the second inverters, the first matching portions, the second matching portions, and the transmission coils may be arranged parallel on a same plane.

The transmission coils, in which conducting wires are wound in a same direction, may be arranged such that central axes of the transmission coils are aligned, and the magnetic fields overlap each other, to increase a charging distance and charging power of wireless power for a single reception coil.

The transmission coils, in which conducting wires are wound in a same direction, may be arranged such that central axes of the transmission coils are parallel to each other, to transmit wireless power to a plurality of reception coils.

The transmission coils, in which conducting wires are wound in opposite directions, may be arranged such that central axes of the transmission coils are aligned, and the magnetic fields are canceled out, to reduce EMF.

According to another aspect, there is provided a wireless charging system including a transmitter including a clock generator configured to generate a clock signal, a single inverter configured to output an inverter voltage/current signal using the clock signal generated by the clock generator, matching portions connected to the inverter and configured to output transmission coil voltage/current signals having a same magnitude and reverse phases from each other using the inverter voltage/current signal, and transmission coils respectively connected to the matching portions and configured to generate magnetic fields towards a reception coil using the transmission coil voltage/current signals, wherein, in the matching portions of the transmitter, a circuit may be configured so that inputs of the inverter voltage/current signal have reverse phases from each other.

The inverter, the matching portions, and the transmitting coils may be arranged parallel on a same plane.

The transmission coils, in which conducting wires are wound in a same direction, may be arranged such that central axes of the transmission coils are aligned, and the magnetic fields overlap each other, to increase a charging distance and charging power of wireless power for a single reception coil.

The transmission coils, in which conducting wires are wound in a same direction, may be arranged such that central axes of the transmission coils are parallel to each other, to transmit wireless power to a plurality of reception coils.

The transmission coils, in which conducting wires are wound in opposite directions, may be arranged such that central axes of the transmission coils are aligned, and the magnetic fields are canceled out, to reduce EMF.

Additional aspects of embodiments will be set forth in part in the description which follows and, in part, will be apparent from the description, or may be learned by practice of the disclosure.

According to an embodiment, through a structure of a transmitter including two or more transmission coils, unnecessary radiation electromagnetic waves radiated by the transmission coils may be attenuated.

According to an embodiment, by operating a transmitter in a single mode through an arrangement structure of two or more transmission coils included in the transmitter, charging distance or charging power for a single receiver may be increased.

According to an embodiment, by operating a transmitter in a multi-mode through an arrangement structure of two or more transmission coils included in the transmitter, multiple receivers may be wirelessly charged simultaneously.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a first structure of a transmitter included in a wireless charging system according to an embodiment;

FIG. 2 is a diagram illustrating a structure of an inverter according to an embodiment;

FIG. 3 is a diagram illustrating a second structure of a transmitter included in a wireless charging system according to an embodiment;

FIGS. 4A and 4B are diagrams illustrating transmission modes according to an arrangement structure of transmission coils included in a transmitter according to an embodiment;

FIG. 5 is a diagram illustrating a third structure of a transmitter included in a wireless charging system according to an embodiment;

FIG. 6 is a diagram illustrating a fourth structure of a transmitter included in a wireless charging system according to an embodiment;

FIG. 7 is a diagram illustrating a fifth structure of a transmitter included in a wireless charging system according to an embodiment; and

FIG. 8 is a diagram illustrating a structure of a matching portion according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

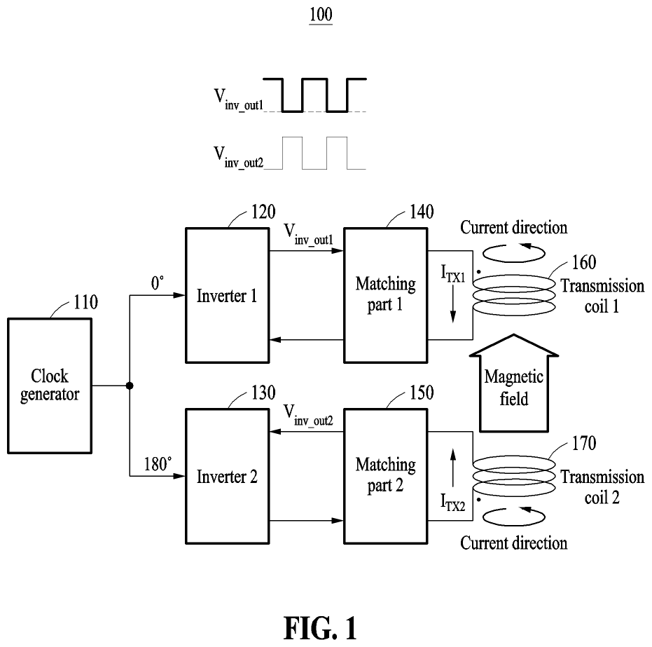

FIG. 1 is a diagram illustrating a first structure of a transmitter included in a wireless charging system according to an embodiment.

Referring to FIG. 1, a transmitter 100 included in a wireless charging system may include a clock generator 110 configured to generate clock signals having reverse phases from each other, inverters 120 and 130 configured to output inverter voltage/current signals having the same magnitude and the reverse phases from each other using the clock signals generated by the clock generator 110, matching portions 140 and 150 respectively connected to the inverters 120 and 130 and configured to output transmission coil voltage/current signals having the same magnitude and the reverse phases from each other using the inverter voltage/current signals, and transmission coils 160 and 170 respectively connected to the matching portions 140 and 150 and configured to generate magnetic fields towards a reception coil using the transmission coil voltage/current signals.

Here, in order to generate a transmission output of tens of kilowatts (kW) or more, the transmitter 100 may require a high-voltage direct current voltage of hundreds of volts (V) or more as an input voltage for each of the inverters 120 and 130. Accordingly, output voltages (V_{inv_out1}, V_{inv_out2}) of the inverters 120 and 130 may each be output as a square wave proportional to the magnitude of the input voltage.

Such an output of the square wave may be the cause of major unnecessary electromagnetic waves generated by the transmitter 100 and may be very difficult to be removed using a general electromagnetic interference (EMI) filter. In addition, when the transmission coil voltage/current signals output from the matching portions 140 and 150 do not form a perfect sine wave, that is, when a resonance point is wrong, this may cause unnecessary electromagnetic waves to be radiated.

In the transmitter 100 of the present disclosure, in order to attenuate such unnecessary electromagnetic waves, the inverters 120 and 130, the matching portions 140 and 150, and the transmission coils 160 and 170, which are after the clock generator 110, may be arranged parallel to each other on the same plane, as shown in FIG. 1.

More specifically, the clock generator 110 may generate signals having reverse phases from each other. For example, the clock generator 110 may generate signals having a phase of 0 degrees and a phase of 180 degrees, as shown in FIG. 1. However, the phase values of the signals are only an example and are not limited to the above examples.

When the input voltages V_{dd} are the same, the inverters 120 and 130 may respectively receive, as an input, the signals generated by the clock generator 110 and having reverse phases from each other to output inverter voltage/current signals having the same magnitude as the input voltage (V_{dd}) but reverse phases from each other. Here, unnecessary electromagnetic waves radiated by the inverter voltage/current signals may cancel each other out due to the reverse phase characteristics of the same magnitude.

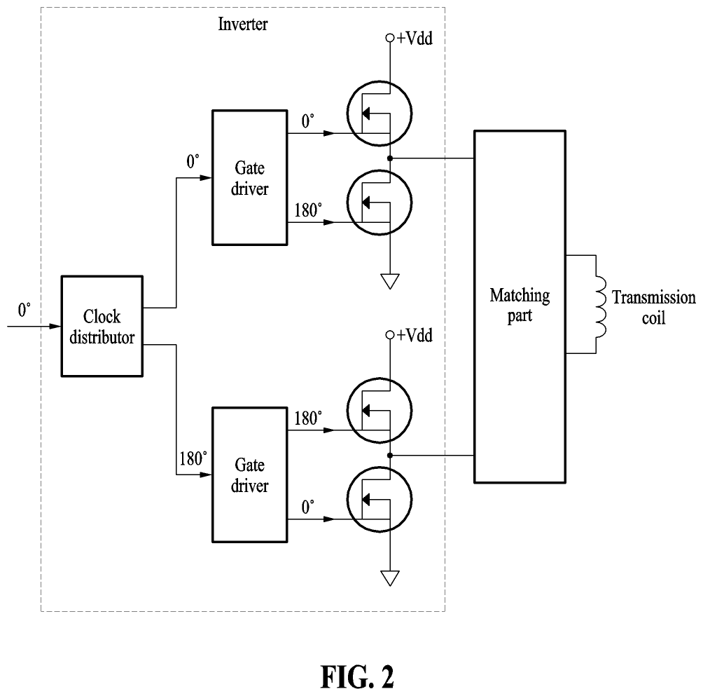

For example, the inverters 120 and 130 may include various amplifiers, including a typical linear power amplifier or a class-D amplifier using a switching element, as shown in FIG. 2. However, the type of amplifiers of the inverters 120 and 130 is only an example and is not limited to the above examples.

The matching portions 140 and 150 may receive, as an input, the inverter voltage/current signals and may output transmission coil voltage/current signals having the same magnitude but reverse phases from each other. Here, the output transmission coil voltage/current signals may be respectively applied to the transmission coils 160 and 170 and may have reverse phase characteristics of the same magnitude, like the inverter voltage/current signals. Accordingly, unnecessary electromagnetic waves radiated from the transmission coils 160 and 170 may also be cancelled out.

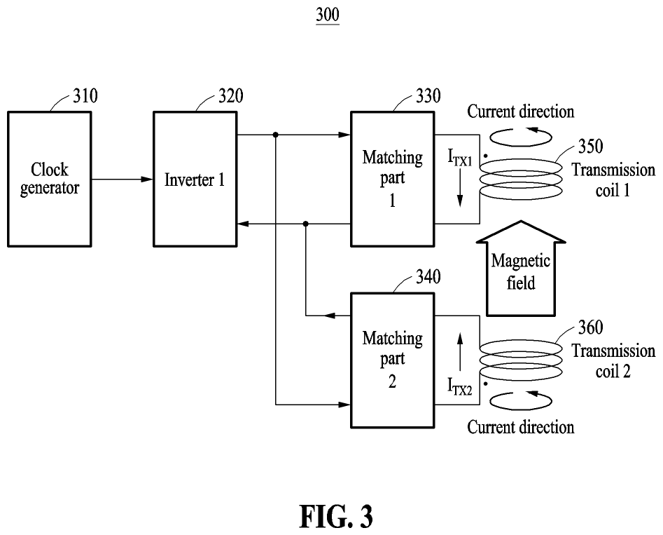

FIG. 3 is a diagram illustrating a second structure of a transmitter included in a wireless charging system according to an embodiment.

FIG. 3 illustrates a structure of a transmitter 300 provided to reduce the number of inverters in the structure of the transmitter 100 provided in FIG. 1 such that the same effect of using two inverters may be provided by using a single inverter.

More specifically, referring to FIG. 3, the transmitter 300 included in a wireless charging system may include a clock generator 310 configured to generate a clock signal, a single inverter 320 configured to output an inverter voltage/current signal using the clock signal generated by the clock generator 310, a first matching portion 330 and a second matching portion 340 each connected to the inverter 320 and configured to output transmission coil voltage/current signals having the same magnitude but reverse phases from each other using the inverter voltage/current signal, and transmission coils 350 and 360 respectively connected to the first matching portion 330 and the second matching portion 340 and configured to generate magnetic fields towards a reception coil using the transmission coil voltage/current signals.

Here, in the transmitter 300, a circuit may be configured so that an input of the first matching portion 330 and an input of the second matching portion 340, each to which the inverter voltage/current signal is applied, may have reverse phases from each other. As a result, the first matching portion 330 and the second matching portion 340 may each receive, as an input, the inverter voltage/current signal and may output transmission coil voltage/current signals having the same magnitude but reverse phases from each other. Here, the output transmission coil voltage/current signals may be respectively applied to the transmission coils 350 and 360 and may have reverse phase characteristics of the same magnitude. Accordingly, unnecessary electromagnetic waves radiated from the transmission coils 350 and 360 may be cancelled out.

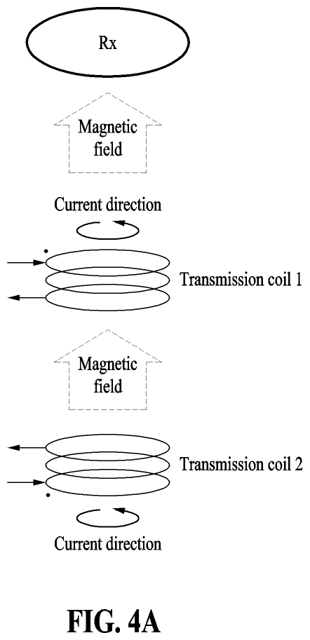

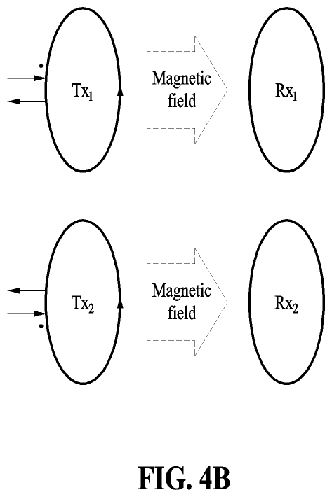

FIGS. 4A and 4B are diagrams illustrating transmission modes according to an arrangement structure of transmission coils included in a transmitter according to an embodiment.

Referring to FIGS. 4A and 4B, the transmission coils included in the transmitter of a wireless charging system may be formed with a helical or spiral structure. Here, as shown in FIG. 4A, when the transmission coils, as conducting wires wound in the same direction, are arranged such that central axes of the transmission coils are aligned, magnetic fields generated by the transmission coils may overlap each other in the direction of the central axes. In this case, the transmitter may operate in a single charging mode to perform wireless charging of a single receiver and the charging distance and charging power for the receiver may be increased by the sum of magnetic field components.

On the contrary, as shown in FIG. 4B, when the transmission coils, as conducting wires wound in the same direction, are arranged such that central axes of the transmission coils are parallel to each other, magnetic fields may be generated in the direction of the central axis of each of the transmission coils. In this case, the transmitter may operate in a multi-charging mode and may perform wireless charging of multiple receivers simultaneously.

Here, when the transmission coils are arranged on a plane or in three dimensions, the transmitter may perform wireless charging of more receivers than the number of transmission coils.

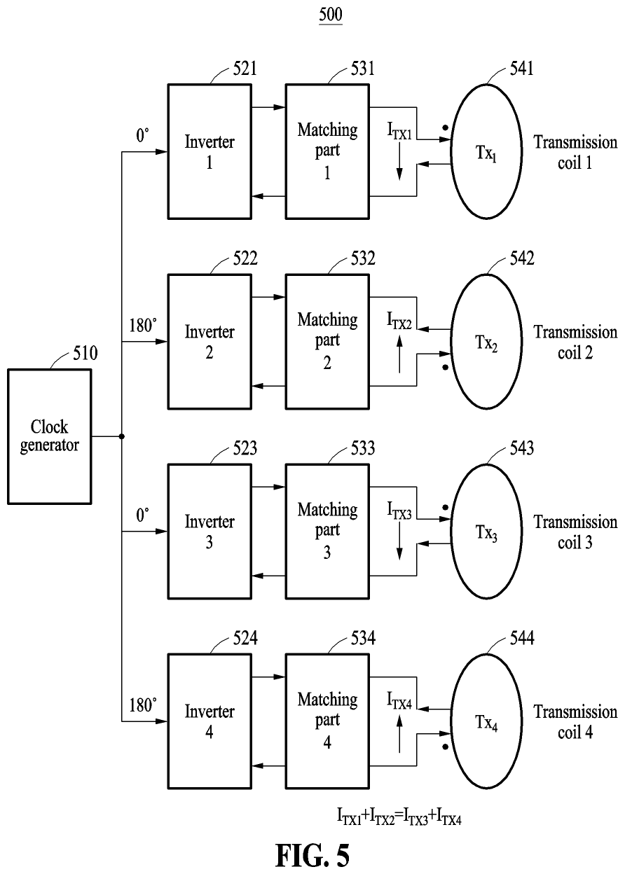

FIG. 5 is a diagram illustrating a third structure of a transmitter included in a wireless charging system according to an embodiment.

FIG. 5 is a diagram illustrating an example in which transmission coils included in a transmitter 500 of a wireless charging system are increased to four. Here, the transmitter 500 may input, to first inverters 521 and 523, a first clock signal among clock signals generated by a clock generator 510 and having reverse phases from each other, and may output inverter voltage/current signals having a first phase. The transmitter 500 may input a second clock signal having a reverse phase from the first clock signal to second inverters 522 and 524 and may output inverter voltage/current signals having a second phase.

Here, first matching portions 531 and 533 may output transmission coil voltage/current signals having the first phase using the inverter voltage/current signals having the first phase, and second matching portions 532 and 534 may output transmission coil voltage/current signals having the second phase using the inverter voltage/current signals having the second phase.

First transmission coil voltage/current signals and second transmission coil voltage/current signals output here may be respectively applied to first transmission coils 541 and 543 and second transmission coils 542 and 544 and may have reverse phase characteristics of the same magnitude, like the inverter voltage/current signals. Accordingly, unnecessary electromagnetic waves radiated from the transmission coils 541 to 544 may be cancelled out.

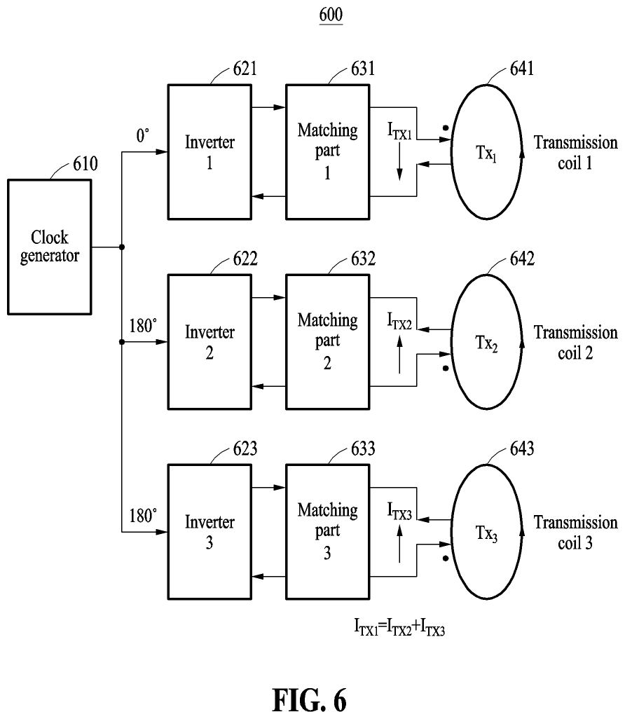

FIG. 6 is a diagram illustrating a fourth structure of a transmitter included in a wireless charging system according to an embodiment.

FIG. 6 is a diagram illustrating an example in which transmission coils included in a transmitter 600 of a wireless charging system are increased to an odd number and are not symmetrical. Here, the transmitter 600 may input, to a first inverter 621, a first clock signal from among clock signals generated by a clock generator 610 and having reverse phases from each other, and may output inverter voltage/current signal having a first phase. The transmitter 600 may input a second clock signal having a reverse phase from the first clock signal to second inverters 622 and 623 and may output inverter voltage/current signals having a second phase.

Here, a first matching portion 631 may output to first transmission coil a transmission coil voltage/current signal having the first phase using the inverter voltage/current signal having the first phase, and second matching portions 632 and 633 may output to second and third transmission coil transmission coil voltage/current signals having the second phase using the inverter voltage/current signals having the second phase.

Accordingly, the transmitter 600 may set each of the first inverter 621 and the second inverters 622 and 623 to control the ratio of the transmission coil voltage/current signal applied to a first transmission coil 641 and the transmission coil voltage/current signals applied to a second transmission coil 642 and a third transmission coil 643 so that the sum of the output transmission coil voltage/current signal having the first phase and the output transmission coil voltage/current signals having the second phase may be the same (I_{TX1}=I_{TX2}+I_{TX3}).

As described above, a first transmission coil voltage/current signal controlled and output by the first inverter 621 and second transmission coil voltage/current signals controlled and output by the second inverters 622 and 623 may be respectively applied to the first transmission coil 641 and the second transmission coils 642 and 643 and may have reverse phase characteristics of the same magnitude, like the inverter voltage/current signals. Accordingly, unnecessary electromagnetic waves radiated from the first transmission coil 641 and the second transmission coils 642 and 643 may be cancelled out.

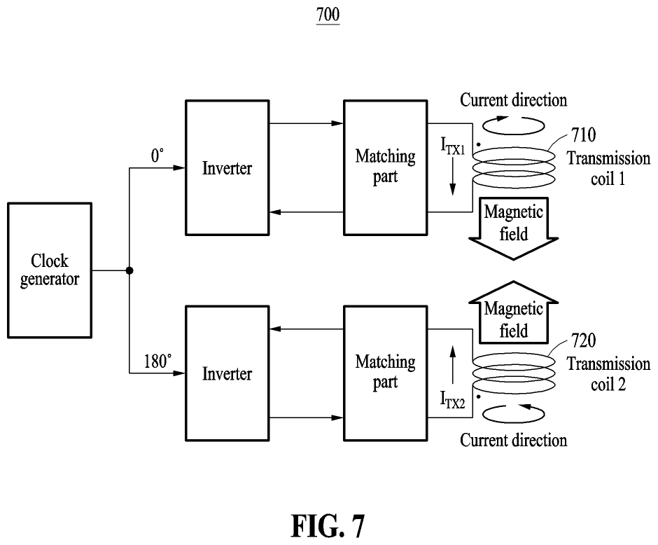

FIG. 7 is a diagram illustrating a fifth structure of a transmitter included in a wireless charging system according to an embodiment.

A transmitter 700 of FIG. 7 may have a structure similar to that of the transmitter 100 of FIG. 1, but FIG. 7 illustrates an example in which transmission coils 710 and 720, as conducting wires wound in opposite directions, are arranged such that central axes of the transmission coils 710 and 720 are aligned. In this example, the transmission coils 710 and 720 included in the transmitter 700 may form magnetic fields in opposite directions, as shown in FIG. 7, so that the magnetic fields may cancel each other out, and thus, the effect of reducing electromotive force (EMF) may be achieved.

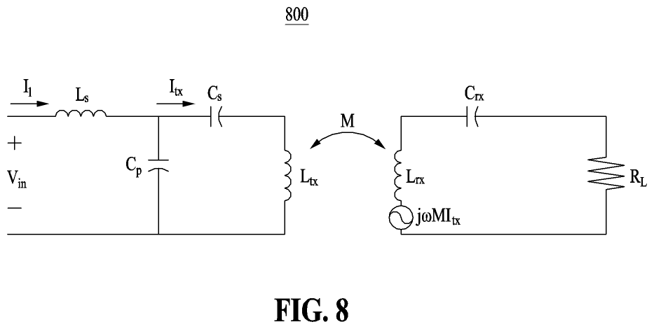

FIG. 8 is a diagram illustrating a structure of a matching portion according to an embodiment.

The matching portion provided by the present disclosure may be matched to a transmission coil through a series-C matching method or a line-commutated converter (LCC) matching method. However, in general, since a structure of a matching portion in an LCC matching method shows excellent performance on reducing unnecessary waves, the present disclosure focuses on the structure of the matching portion using the LCC matching method.

Referring to FIG. 8, a matching portion 800 using the LCC matching method may have a constant current of a transmission coil, as shown in Equation 2, under a resonance condition shown in Equation 1 below.

$$ω = \frac{1}{\sqrt{{L}_{s} {C}_{p}}} , \qquad [ Equation 1 ]$$

$$ω = \frac{1}{\sqrt{( {L}_{tx} - {L}_{s} ) {C}_{s}}}$$

$${I}_{tx} = - j ω {C}_{p} {V}_{in} \qquad [ Equation 2 ]$$

Here, ω denotes a frequency, Lₜₓ denotes a transmission coil, Iₜₓ denotes a target current, and Vᵢₙ denotes an input voltage.

Here, if the frequency ω, the target current Iₜₓ, the input voltage Vᵢₙ, and the transmission coil Lₜₓ are selected, a Cₚ value of a matching portion may be selected using Equation 2 above. In addition, if the selected Cₚ value is applied to a resonance condition

$$ω = \frac{1}{\sqrt{{L}_{s} {C}_{p}}} ,$$

an Lₛ value of the matching portion may be selected, and if the selected Lₛ value is applied to a resonance condition

$$ω = \frac{1}{\sqrt{( {L}_{tx} - {L}_{s} ) {C}_{s}}} ,$$

a Cₛ value of the matching portion may be selected.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A wireless charging system comprising:
a transmitter comprising:
a clock generator configured to generate clock signals having reverse phases from each other;
inverters configured to output inverter voltage/current signals having a same magnitude and reverse phases from each other, using the clock signals generated by the clock generator;
matching portions respectively connected to the inverters and configured to output transmission coil voltage/current signals having a same magnitude and reverse phases from each other, using the inverter voltage/current signals; and
transmission coils respectively connected to the matching portions and configured to generate magnetic fields towards a reception coil using the transmission coil voltage/current signals,
wherein the transmitter is configured to attenuate unnecessary electromagnetic waves radiated from the transmitter by the inverter voltage/current signals that are output from the inverters and that have the same magnitude and the reverse phases from each other and by the transmission coil voltage/current signals that are output from the matching portions and that have the same magnitude and the reverse phases from each other.

2. The wireless charging system of claim 1, wherein
the inverters, the matching portions, and the transmission coils are arranged in parallel on a same plane.

3. The wireless charging system of claim 1, wherein
the transmission coils, in which conducting wires are wound in a same direction, are arranged such that central axes of the transmission coils are aligned, and the magnetic fields overlap each other, to increase a charging distance and charging power of wireless power for a single reception coil.

4. The wireless charging system of claim 1, wherein
the transmission coils, in which conducting wires are wound in a same direction, are arranged such that central axes of the transmission coils are parallel to each other, to transmit wireless power to a plurality of reception coils.

5. The wireless charging system of claim 1, wherein
the transmission coils, in which conducting wires are wound in opposite directions, are arranged such that central axes of the transmission coils are aligned, and the magnetic fields are canceled out, to reduce electromotive force (EMF).

6. A wireless charging system comprising:
a transmitter comprising:
a clock generator configured to generate clock signals;
first inverters configured to output inverter voltage/current signals having a first phase using a first clock signal among the clock signals generated by the clock generator;
second inverters configured to output inverter voltage/current signals having a second phase using a second clock signal having a reverse phase from the first clock signal among the clock signals;
first matching portions respectively connected to the first inverters and configured to output transmission coil voltage/current signals having the first phase, using the inverter voltage/current signals having the first phase;
second matching portions respectively connected to the second inverters and configured to output transmission coil voltage/current signals having the second phase, using the inverter voltage/current signals having the first phase; and
transmission coils respectively connected to the first matching portions and the second matching portions and configured to generate magnetic fields towards a reception coil using the transmission coil voltage/current signals having the first phase and the transmission coil voltage/current signals having the second phase.

7. The wireless charging system of claim 6, wherein
the first inverters and the second inverters are configured to be set so that a sum of the transmission coil voltage/current signals having the first phase is equal to a sum of the transmission coil voltage/current signals having the second phase.

8. The wireless charging system of claim 6, wherein
the first inverters, the second inverters, the first matching portions, the second matching portions, and the transmission coils are arranged parallel on a same plane.

9. The wireless charging system of claim 6, wherein
the transmission coils, in which conducting wires are wound in a same direction, are arranged such that central axes of the transmission coils are aligned, and the magnetic fields overlap each other, to increase a charging distance and charging power of wireless power for a single reception coil.

10. The wireless charging system of claim 6, wherein
the transmission coils, in which conducting wires are wound in a same direction, are arranged such that central axes of the transmission coils are parallel to each other, to transmit wireless power to a plurality of reception coils.

11. The wireless charging system of claim 6, wherein
the transmission coils, in which conducting wires are wound in opposite directions, are arranged such that central axes of the transmission coils are aligned, and the magnetic fields are canceled out, to reduce electromotive force (EMF).

12. A wireless charging system comprising:
a transmitter comprising:
a clock generator configured to generate a clock signal;
a single inverter configured to output an inverter voltage/current signal using the clock signal generated by the clock generator;
matching portions connected to the inverter and configured to output transmission coil voltage/current signals having a same magnitude and reverse phases from each other, using the inverter voltage/current signal; and
transmission coils respectively connected to the matching portions and configured to generate magnetic fields towards a reception coil, using the transmission coil voltage/current signals,
wherein, in the matching portions of the transmitter, a circuit is configured so that inputs of the inverter voltage/current signal have reverse phases from each other.

13. The wireless charging system of claim 12, wherein
the inverter, the matching portions, and the transmitting coils are arranged parallel on a same plane.

14. The wireless charging system of claim 12, wherein
the transmission coils, in which conducting wires are wound in a same direction, are arranged such that central axes of the transmission coils are aligned, and the magnetic fields overlap each other, to increase a charging distance and charging power of wireless power for a single reception coil.

15. The wireless charging system of claim 12, wherein
the transmission coils, in which conducting wires are wound in a same direction, are arranged such that central axes of the transmission coils are parallel to each other, to transmit wireless power to a plurality of reception coils.

16. The wireless charging system of claim 12, wherein
the transmission coils, in which conducting wires are wound in opposite directions, are arranged such that central axes of the transmission coils are aligned, and the magnetic fields are canceled out, to reduce electromotive force (EMF).
